(19) United States
(12) Patent Application Publication
(10) Pub. No.: US 2021/0401650 A1
(43) Pub. Date: Dec. 30, 2021

(54) WAISTBAND CONFIGURED TO PROVIDE A STRONG, SAFE, AND WEARABLE PAIR OF SHORTS, PANTS OR SKIRT CONFIGURED TO ASSIST TRANSFERRING A WEARER SAFELY FROM SITTING TO STANDING AND STANDING TO SITTING

(71) Applicant: Up-On3 LLC, Matthews, NC (US)

(72) Inventors: Peter THOMPSON, Matthews, NC (US); Marsha THOMPSON, Matthews, NC (US)

(21) Appl. No.: 17/362,778

(22) Filed: Jun. 29, 2021

Related U.S. Application Data
(60) Provisional application No. 63/046,472, filed on Jun. 30, 2020.

(51) Int. Cl. A61G 7/10; A41F 9/00

(52) U.S. Cl. CPC A61G 7/1051; A61G 2200/36; A61G 2200/34; A41F 9/00

(57) ABSTRACT

A waistband configured to assist transferring a wearer safely from sitting to standing or standing to sitting. The waistband includes a strong belt material. The strong belt material is connected along a waistline of the waistband. The strong belt material is configured to provide a plurality of handles. Wherein, each of the plurality of handles is configured to assist in transferring the wearer of the waistband from sitting to standing or from standing to sitting.

### CROSS-REFERENCE To RELATED APPLICATIONS

This application claims benefit to U.S. Provisional Patent Application No. 63/046,472, filed on Jun. 30, 2020, entitled “Strong, Safe Wearable Pair of Shorts, Pants or Skirt to Assist Transferring a Person Safely from Sitting to Standing and Standing to Sitting”, which is incorporated herein by reference in its entirety.

### FIELD OF THE DISCLOSURE

The present disclosure is related to the health care industry. More specifically, the present disclosure is directed to a waistband configured for creating a pair of strong, safe wearable pair of shorts, pants, or skirt configured to assist transferring a wearer safely from sitting to standing and standing to sitting.

### BACKGROUND

Generally speaking, a waistband is a strip of cloth forming the waist of a garment such as a skirt or a pair of trousers. As such, a waistband is a strip of material that is either elastic or some other confining fabric that encircles the waist. Up to now, the waistband is only known added uses are to limit expansion of the stomach to meet various objectives including to help prevent overeating, to encourage mindful eating, to encourage good posture, or to immediately slim the appearance of the waist (much like a corset, also sometimes called a waist cincher).

Many people have the need or handicap that require them to receive assistance when transitioning from sitting to standing and/or from standing to sitting. These people may include, but are not limited to, handicapped individuals, patients at home or in hospitals recovering from surgeries or procedures, the elderly, the like etc.

Currently, the solution to aid such individuals from transitioning from sitting to standing and/or from standing to sitting may be for a nurse or CNA to hold or pull the individual up from under their arms or even to stick their hand down brief underwear to pull or assist the patient. As should be clearly understood, this may not only be unsanitary or grotesque, but very undignified for the individual or patient. Therefore, a need exists for a device, means, method and/or mechanism to aid care givers, like nurses or CNAs, in transitioning such individuals from sitting to standing and/or from standing to sitting that is more sanitary and less intrusive to the individual or patient.

The instant disclosure may be designed to address at least certain aspects of the problems or needs discussed above by providing a waistband configured to provide a strong, safe, and wearable pair of shorts, pants, skirt, overalls, or the like, where the waistband is configured to assist the wearer safely from sitting to standing and/or from standing to sitting.

### SUMMARY

The present disclosure may solve the aforementioned limitations of the currently available device, means, method and/or mechanism to aid care givers, like nurses or CNAs, in transitioning individuals from sitting to standing and/or from standing to sitting, by providing a waistband configured to assist transferring a wearer safely from sitting to standing or standing to sitting. The disclosed waistband may provide a device, means, method, and/or mechanism to aid care givers, like nurses or CNAs, in transitioning individuals from sitting to standing and/or from standing to sitting, by providing a waistband configured to assist transferring a wearer safely from sitting to standing or standing to sitting that is more sanitary and less intrusive to the individual wearer or patient. In general, the disclosed waistband may include a strong belt material. The strong belt material may be connected along a waistline of the waistband. The strong belt material may be configured to provide a plurality of handles. Wherein, each of the plurality of handles may be configured to assist in transferring the wearer of the waistband from sitting to standing or from standing to sitting.

In select embodiments of the disclosed waistband configured to assist transferring a wearer safely from sitting to standing or standing to sitting, the plurality of handles provided by the strong belt material may include a first handle and a second handle. The first handle may protrude from a left side of the waistline. The first handle may be configured to assist in transferring the wearer of the waistband from sitting to standing or from standing to sitting from a left side of the wearer. The second handle may protrude on a right side of the waistline. The second handle may be configured to assist in transferring the wearer of the waistband from sitting to standing or from standing to sitting from a right side of the wearer. In other select embodiments of the disclosed waistband, the strong belt material may further include or provide a third handle. The third handle may protrude from a back side of the waistline. The third handle may be configured to assist in transferring the wearer of the waistband from sitting to standing or from standing to sitting from a back side of the wearer. In select embodiments, but clearly not limited thereto, the third handle protruding from the back side of the waistline may be larger than the first handle on the left side of the waistline and the second handle on the right side of the waistline. Wherein, the plurality of handles may be configured for providing a means to assist in transferring the wearer of the waistband from sitting to standing or from standing to sitting from the left side of the wearer, the right side of the wearer, and/or the back side of the wearer.

Another feature of the disclosed waistband configured to assist transferring a wearer safely from sitting to standing or standing to sitting may be the inclusion of a connector mechanism. The connector mechanism may be configured to releasably connect a first end of the strong belt material to a second end of the strong belt material. In select embodiments, the connector mechanism of the strong belt material may be positioned on a front side of the waistline. Wherein, the connector mechanism may be releasably connected for the wearer to put on or remove the waistband. In select embodiments, the connector mechanism may be adjustable. In these adjustable embodiments, a length of the strong belt material may be adjusted for the waistline. In select embodiments, but clearly not limited thereto, the connector mechanism may be a side release buckle. The side release buckle may include a female end fixed on the first end of the strong belt material and a male end slidably engaged on the second end of the strong belt material. Wherein, the side release buckle may be configured to releasably affix the female end with the male end. In addition, the male end slidably engaged on the second end of the strong belt material may be configured to adjust the length of the strong belt material for providing the waistline configured for the wearer.

In select embodiments of the disclosed waistband configured to assist transferring a wearer safely from sitting to standing or standing to sitting, the strong belt material may include a webbing. The webbing may be, but is clearly not limited thereto, approximately 1 yard. The webbing may be any desired strong and sturdy material, including, but not limited thereto, cotton, nylon, leather, polyester, self-fabric, the like, and/or combinations thereof.

Another feature of the disclosed waistband configured to assist transferring a wearer safely from sitting to standing or standing to sitting may be that the waistline can include an elastic band. The elastic band may be configured and designed to operate similar to a standard elastic waistband of a garment, like shorts, pants, skirts, overalls, etc. In select embodiments, the elastic band may include a solid inner covering material, a slotted outer covering material with a plurality of slots, and an elastic material therebetween the solid inner covering material and the slotted outer covering material. The strong belt material may be arranged in and out of an outside of the elastic band through the plurality of slots of the slotted outer covering material for providing the plurality of handles protruding on the outside of the elastic band. Wherein, the slotted outer covering material may include two slots for each of the plurality of handles. Whereby the strong belt material may be arranged to protrude out of the elastic band at a location of each of the plurality of handles. In select embodiments, the slotted outer covering material may include a first left slot and a second left slot, and a first right slot and a second right slot. The first left slot and the second left slot may be configured for the first handle protruding from the left side of the waistline, where the first handle is configured to assist in transferring the wearer of the waistband from sitting to standing or from standing to sitting from a left side of the wearer. The first right slot and the second right slot may be configured for a second handle protruding from a right side of the waistline. The second handle may be configured to assist in transferring the wearer of the waistband from sitting to standing or from standing to sitting from a right side of the wearer. In select other embodiments, the slotted outer covering material may include a first back slot and a second back slot. The first back slot and the second back slot may be configured for a third handle protruding from a back side of the waistline. The third handle may be configured to assist in transferring the wearer of the waistband from sitting to standing or from standing to sitting from a back side of the wearer. In other select embodiments, the slotted outer covering material may further include a first front slot and a second front slot. The first front slot and the second front slot may be configured for a connector member portion on a front side of the waistline. The connector member portion on the front side of the waistline may be configured for providing the connector mechanism configured to releasably connecting the first end of the strong belt material to the second end of the strong belt material. In other select embodiments, each of the slots of the slotted outer covering material may include a reinforcement. The reinforcement may be configured for reinforcing each of the slots. In select embodiments, the reinforcement of each slot may include vertical topstitching on each side of each slot. In select other embodiments, the reinforcement of each slot may include bar tacks on a top side and a bottom side of each slot. The bar tacks may be stitched through the solid inner covering material, the slotted outer covering material, and the elastic material.

Another feature of the disclosed waistband configured to assist transferring a wearer safely from sitting to standing or standing to sitting may be the inclusion of heavy-duty thread stitching, including, but not limited to, heavy duty nylon thread stitching. The heavy-duty stitching may be configured to provide strength and stability to the elastic band. In select embodiments, the heavy duty nylon thread stitching may include, but is not limited thereto, top stitching configured for reinforcing the top of the waistline. Wherein, the waistline may be designed and configured for providing a breaking strength of approximately 213.6 pound force.

Another feature of the disclosed waistband configured to assist transferring a wearer safely from sitting to standing or standing to sitting may be that it can be configured for use in a garment. The garment that the disclosed waistband is used on may include, but is not limited thereto, a pair of shorts, a pair of pants, a skirt, overalls, the like, and/or any other various garment or apparel item with a waistband.

In another aspect, the instant disclosure embraces the disclosed waistband configured to assist transferring a wearer safely from sitting to standing or standing to sitting in any of the various embodiments and/or combination of embodiments shown and/or described herein.

In another aspect, the instant disclosure embraces a garment. The garment may be any garment, including, but not limited thereto, a pair of shorts, a pair of pants, a skirt, overalls, the like, and/or any other various garment or apparel item with a waistband. The garment may generally include the disclosed waistband configured to assist transferring a wearer safely from sitting to standing or standing to sitting in any of the various embodiments and/or combination of embodiments shown and/or described herein. As such, the garment may include the waistband configured to assist transferring a wearer safely from sitting to standing or standing to sitting, the waistband. The waistband may generally include the strong belt material connected along a waistline of the waistband. The strong belt material may be configured to provide a plurality of handles. Wherein, each of the plurality of handles provided by the waistband on the garment may be configured to assist in transferring the wearer of the waistband from sitting to standing or from standing to sitting. In select embodiments, the disclosed garment may be a pair of shorts, a pair of pants, or a skirt. Wherein, the waistband may be connected to the pair of shorts, the pair of pants, or the skirt.

In another aspect, the instant disclosure embraces a method to assist in transferring a wearer safely from sitting to standing or standing to sitting. The disclosed method to assist in transferring a wearer safely from sitting to standing or standing to sitting may generally include utilizing the disclosed waistband and/or garment configured to assist transferring a wearer safely from sitting to standing or standing to sitting in any of the various embodiments and/or combination of embodiments shown and/or described herein. As such, the disclosed method to assist in transferring a wearer safely from sitting to standing or standing to sitting may include the step of providing the disclosed garment with the disclosed waistband configured to assist transferring the wearer safely from sitting to standing or standing to sitting. With the provided garment, the disclosed method to assist in transferring a wearer safely from sitting to standing or standing to sitting may further include putting the garment on the wearer; and using at least one of the plurality of handles to assist the wearer from transferring safely from sitting to standing or standing to sitting.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1A shows a front view of a waistband according to select embodiments of the instant disclosure configured to provide a strong, safe, and wearable pair of shorts, pants, skirt, or the like, where the waistband is configured to assist the wearer safely from sitting to standing and/or from standing to sitting.

FIG. 1B shows a back view of the waistband from FIG. 1A;

FIG. 1C shows a right side view of the waistband from FIG. 1A with broken away portions of the waistline showing the layers or components of the elastic band;

FIG. 1D shows a left side view of the waistband from FIG. 1A with broken away portions of the waistline showing the layers or components of the elastic band;

FIG. 2A shows a front view of a pair of shorts with a waistband according to select embodiments of the instant disclosure configured to assist the wearer safely from sitting to standing and/or from standing to sitting;

FIG. 2B shows a rear view of the pair of shorts from FIG. 2A with the waistband according to select embodiments of the instant disclosure configured to assist the wearer safely from sitting to standing and/or from standing to sitting;

FIG. 2C shows a side view of the pair of shorts from FIG. 2A with the waistband according to select embodiments of the instant disclosure configured to assist the wearer safely from sitting to standing and/or from standing to sitting;

FIG. 3 shows an environmental view of the pair of shorts from FIG. 2A with the waistband in use with a caregiver assisting the wearer from transitioning from sitting to standing or from standing to sitting by utilizing the handles on each side of the waistband;

FIG. 4 shows a front view of a pair of pants with a waistband according to select embodiments of the instant disclosure configured to assist the wearer safely from sitting to standing and/or from standing to sitting;

FIG. 5 shows a front view of a skirt with a waistband according to select embodiments of the instant disclosure configured to assist the wearer safely from sitting to standing and/or from standing to sitting; and

FIG. 6 shows a flow chart of a method of assisting an individual from sitting to standing or from standing to sitting according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

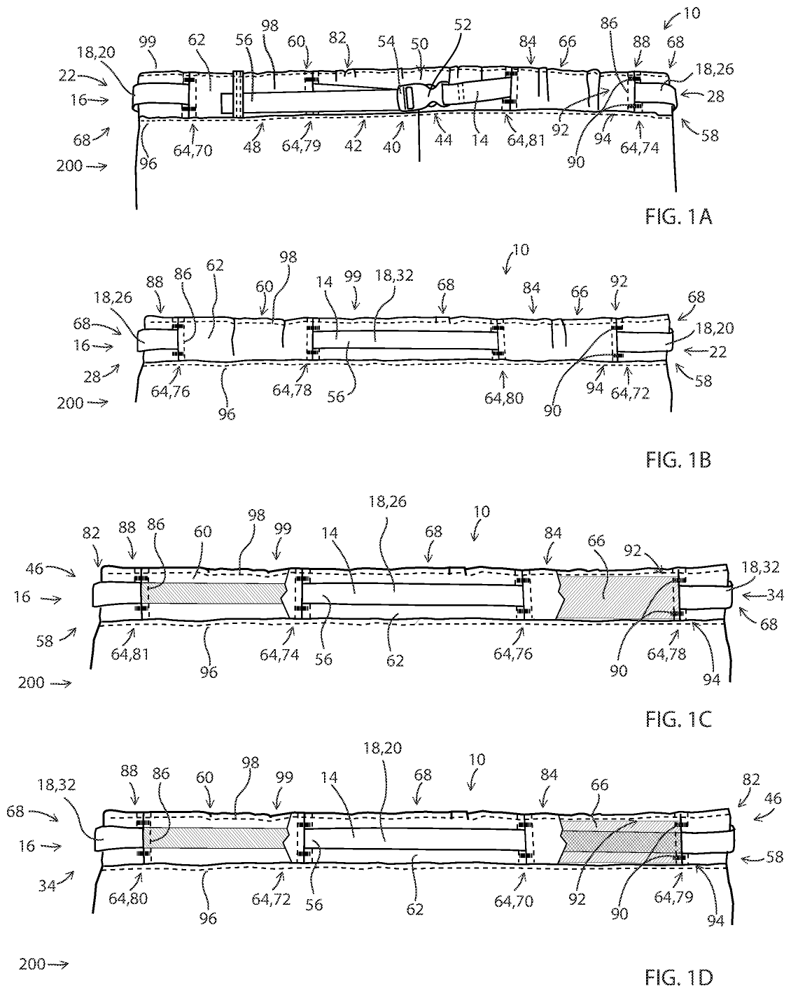

Referring now to FIGS. 1-6, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

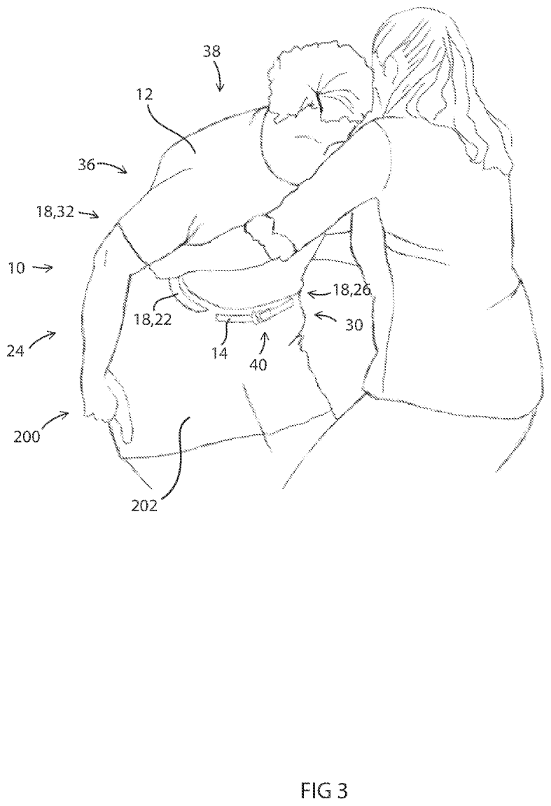

Referring now to FIGS. 1-5, the present disclosure may solve the aforementioned limitations of the currently available devices, means, methods and/or mechanisms to aid care givers, like nurses or CNAs, in transitioning individuals from sitting to standing and/or from standing to sitting, by providing waistband 10 configured to assist transferring wearer 12 safely from sitting to standing or standing to sitting (see FIG. 3). Waistband 10 may be designed and/or configured to provide a device, means, method, and/or mechanism to aid care givers, like nurses or CNAs, in transitioning individuals from sitting to standing and/or from standing to sitting. As shown in FIG. 3, waistband 10 may be configured to assist transferring wearer 12 safely from sitting to standing or standing to sitting that is more sanitary and less intrusive wearer 12 or patient. In general, waistband 10 may include strong belt material 14. Strong belt material 14 may be connected along waistline 16 of waistband 10. Strong belt material 14 may be configured to provide plurality of handles 18. Wherein, each of the plurality of handles 18 may be configured to assist in transferring wearer 12 of waistband 10 from sitting to standing, or from standing to sitting, like as shown in FIG. 3.

In select embodiments waistband 10, the plurality of handles 18 provided by strong belt material 14 may include first handle 20 and second handle 26. First handle 20 may protrude from left side 22 of waistline 16. First handle 20 may be configured to assist in transferring wearer 12 of waistband 10 from sitting to standing or from standing to sitting from left side 24 of the wearer. On the other side, second handle 26 may protrude on right side 28 of waistline 16. Second handle 26 may be configured to assist in transferring wearer 12 of waistband 10 from sitting to standing or from standing to sitting from right side 30 of wearer 12. In other select embodiments of waistband 10, strong belt material 14 may further include or provide third handle 32. Third handle 32 may protrude from back side 34 of waistline 16. Third handle 32 may be configured to assist in transferring wearer 12 of waistband 10 from sitting to standing or from standing to sitting from back side 36 of wearer 12. In select embodiments, but clearly not limited thereto, third handle 32 protruding from back side 34 of waistline 16 may be larger or slightly larger than first handle 20 on left side 22 of waistline 16 and second handle 26 on right side 28 of waistline 16. In other select embodiments, but clearly not limited thereto, third handle 32 protruding from back side 34 of waistline 16 may be equal to or approximately equal to first handle 20 on left side 22 of waistline 16 and second handle 26 on right side 28 of waistline 16. Wherein, as shown in FIG. 3, the plurality of handles 18 may be provided, designed and configured for providing means 38 to assist in transferring wearer 12 of waistband 10 from sitting to standing or from standing to sitting from left side 24 of wearer 12, right side 30 of wearer 12, and/or back side 34 of wearer 12.

Another feature of waistband 10 configured to assist transferring wearer 12 safely from sitting to standing or standing to sitting may be the inclusion of connector mechanism 40. See FIGS. 1A, 2A, 4 and 5. Connector mechanism 40 may be provided, designed and/or configured to releasably connect first end 42 of strong belt material 14 to second end 44 of strong belt material 14. Connector mechanism 40 may be any device or may include any device, components, and or means for releasably connect first end 42 of strong belt material 14 to second end 44 of strong belt material 14. As shown in the Figures, connector mechanism 40 of strong belt material 14 may be positioned on front side 46 of waistline 16. In select embodiments, connector mechanism 40 may be releasably connected for wearer 12 to put on or remove waistband 10. In select embodiments, connector mechanism 40 may be adjustable. In these adjustable embodiments, length 48 of strong belt material 14 may be adjusted for waistline 16. In select embodiments, but clearly not limited thereto, as shown in the Figures, connector mechanism 40 may be side release buckle 50. Side release buckle 50 may include female end 52 fixed on first end 42 of strong belt material 14 and male end 54 slidably engaged on second end 44 (or vice versa) of strong belt material 14. Wherein, side release buckle 50 may be configured to releasably affix female end 52 with male end 54. In addition, male end 54 slidably engaged on second end 44 of strong belt material 14 may be configured to adjust length 48 of strong belt material 14 for providing waistline 16 configured for wearer 12. Connector mechanism 40 being provided on front side 46 of waistline 16 may allow for connector mechanism 40 to be used by wearer 12 like a standard belt in conjunction with any buttons, snaps, zippers, hook and loop type fasteners or enclosures, the like, etc. on garment 200. As an example, and clearly not limited thereto, garment 200 may be constructed with a hook and loop type fastener fly portion including a hook and loop type fastener fly and waistline connector portion. This fully hook and loop type fastener fly configuration for garment 200 may aid in wearer 12 and/or any care givers or nurses for putting on and/or removing garment 200 with waistband 10. In addition, in select embodiments, a hole or aperture may be included in garment 200, like through the fly or an area close to the fly. In this embodiment, the hole or aperture may be included for providing a means for a catheter, the like, or its associated tubing to be conveniently inserted through garment 200. This hole or aperture through garment 200 may be especially useful in pants 204.

Strong belt material 14 may be provide in any various size and/or materials configured for waistline 16 and/or for having the strength and durability to assist transferring wearer 12 safely from sitting to standing or standing to sitting. In select embodiments of waistband 10 configured to assist transferring wearer 12 safely from sitting to standing or standing to sitting, strong belt material may include webbing 56. Webbing 56 may be, but is clearly not limited thereto, having length 48 of approximately 1 yard. Webbing 56 may be any desired strong and sturdy material, including, but not limited thereto, cotton, nylon, leather, polyester, self-fabric, the like, and/or combinations thereof. In select embodiments, webbing 56 of strong belt material 14 may be from ½ inch to 2.5 inches wide. In select possibly preferred embodiments, webbing 56 may be a 1 inch wide webbing of such material.

Elastic band 58 may be included as a portion or component of waistband 10 configured to assist transferring wearer 12 safely from sitting to standing or standing to sitting. See FIGS. 1-5. Elastic band 58 may be configured and designed to operate similar to a standard elastic waistband of a garment, like shorts, pants, skirts, overalls, the like, etc. In select embodiments, elastic band 58 of waistline 16 for waistband 10 may be from 1 inch to 3 inches wide. In select, possibly preferred embodiments, elastic band 58 of waistline 16 for waistband 10 may be approximately 1.5 inches wide. Elastic band 58 of waistline 16 for waistband 10 may be made of many various materials designed to be strong and durable and may preferably be woven materials. The material fibers can vary and can preferably contain a slight stretch. In select embodiments, elastic band 58 may include solid inner covering material 60, slotted outer covering material 62 with a plurality of slots 64, and elastic material 66 therebetween solid inner covering material 60 and slotted outer covering material 62. As shown in the Figures, strong belt material 14 may be arranged in and out of an outside of elastic band 58 through plurality of slots 64 of slotted outer covering material 62 for providing the plurality of handles 18 protruding on the outside of elastic band 58. Wherein, slotted outer covering material 62 may include two slots 64 for each of the plurality of handles 18. Whereby, strong belt material 14 may be arranged to protrude out of elastic band 58 at locations 68 of each of the plurality of handles 18. In select embodiments, each slot 64 may be 1 inch tall openings or slots in slotted outer covering material 62 designed and configured to allow a 1 inch wide webbing 56 of strong belt material 14 to move therethrough. In select embodiments, slotted outer covering material 62 may include first left slot 70 and second left slot 72, and first right slot 74 and second right slot 76. First left slot 70 and second left slot 72 may be configured for first handle 20 protruding from left side 22 of waistline 16, where first handle 20 is configured to assist in transferring wearer 12 of waistband 10 from sitting to standing or from standing to sitting from left side 24 of wearer 12. First right slot 74 and second right slot 76 may be configured for second handle 26 protruding from right side 28 of waistline 16. Second handle 26 may be configured to assist in transferring wearer 12 of waistband 10 from sitting to standing or from standing to sitting from right side 30 of wearer 12. In select other embodiments, slotted outer covering material 62 may further include first back slot 78 and second back slot 80. First back slot 78 and second back slot 80 may be configured for third handle 32 protruding from back side 34 of waistline 16. Third handle 32 may be configured to assist in transferring wearer 12 of waistband 10 from sitting to standing or from standing to sitting from back side 36 of wearer 12. In other select embodiments, slotted outer covering material 62 may further include first front slot 79 and second front slot 81. First front slot 79 and second front slot 81 may be configured for connector member portion 82 on front side 46 of waistline 16. Connector member portion 82 on front side 46 of waistline 16 may be configured for providing connector mechanism 40 configured to releasably connect first end 42 of strong belt material 14 to second end 44 of strong belt material 14. Connector member portion 82 may also serve as a fourth handle on front side 46 of waistline 16 configured to assist in transferring wearer 12 of waistband 10 from sitting to standing or from standing to sitting from the front side of wearer 12. In other select embodiments, each of the slots 64 of slotted outer covering material 62 may include reinforcement 84. Reinforcements 84 may be configured for reinforcing each of the slots 64 in slotted outer covering material 62. In select embodiments, reinforcements 84 of each slot 64 may include vertical topstitching 86 on each side 88 of each slot 64. In select other embodiments, reinforcements 84 of each slot 64 may include bar tacks 90 on top side 92 and bottom side 94 of each slot 64. Bar tacks 90 may be stitched through solid inner covering material 60, slotted outer covering material 63, and elastic material 66. In select embodiments, elastic band 58 may include a reinforcing material or layer of reinforcing material sewn together with solid inner covering material 60 where strong belt material 14 still move freely. In select embodiments, this reinforcing material or layer of reinforcing material may be along the entire waistband 10. In possibly preferred embodiments, the reinforcing material or layer of reinforcing material may include multiple strips or pieces of the reinforcing material positioned in locations 68 of each of handles 18 between each of said slots 64 in slotted outer cover material 62.

Heavy-duty thread stitching 96 may also be included as another feature of waistband 10 configured to assist transferring wearer 12 safely from sitting to standing or standing to sitting. Heavy-duty stitching 96 may be configured to provide strength and stability to elastic band 58 of waistband 10. Heavy-duty thread stitching 96 may be any stitching or heavy-duty stitching, including, but not limited to, heavy duty nylon thread stitching. Heavy-duty thread stitching 96 may be used for reinforcements 84, including, but not limited to, topstitching 86, bar tacks 90, the like, and/or combinations thereof. In select embodiments, heavy duty thread stitching 96 may include, but is not limited thereto, top stitching 98 configured for reinforcing top 99 of waistline 16. Wherein, waistband 10 may be designed and configured for providing a desired breaking strength configured to aid in assisting transferring wearer 12 safely from sitting to standing or standing to sitting. The desired breaking strength provided by waistband 10 may include, but is not limited to, at least 100 pound-force, possibly at least 150 pound-force, most possibly at least 200 pound-force. In select embodiments, the breaking strength provided by waistband 10 may be configured to provide approximately 213.6 pound force according to ASTM D 5034-09 “Standard Test Method for Breaking Strength and Elongation of Textile Fabrics (Grab Test), where testing was modified with the webbing secured in the top clamp and the sewn seam of the bottom belt loop secured in the bottom clamp of the Instron machine.

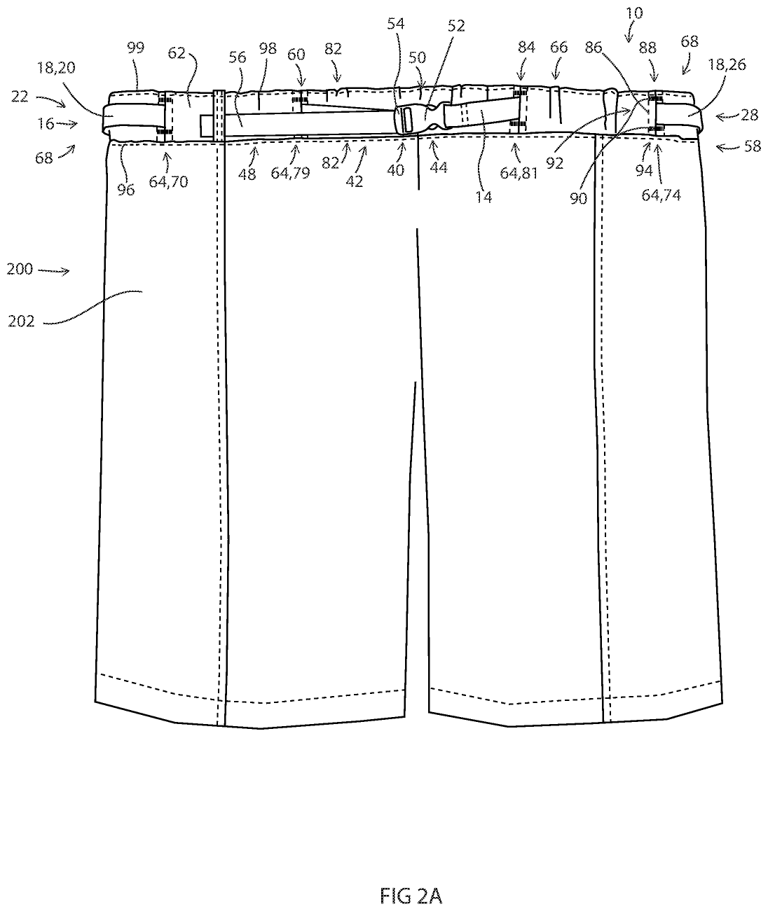

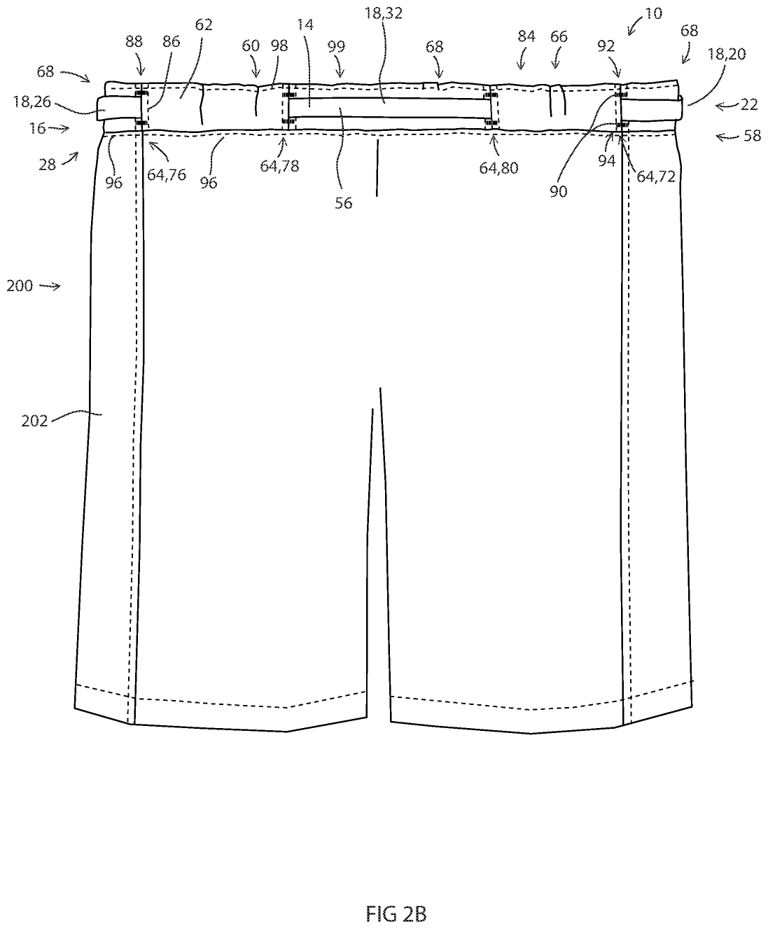

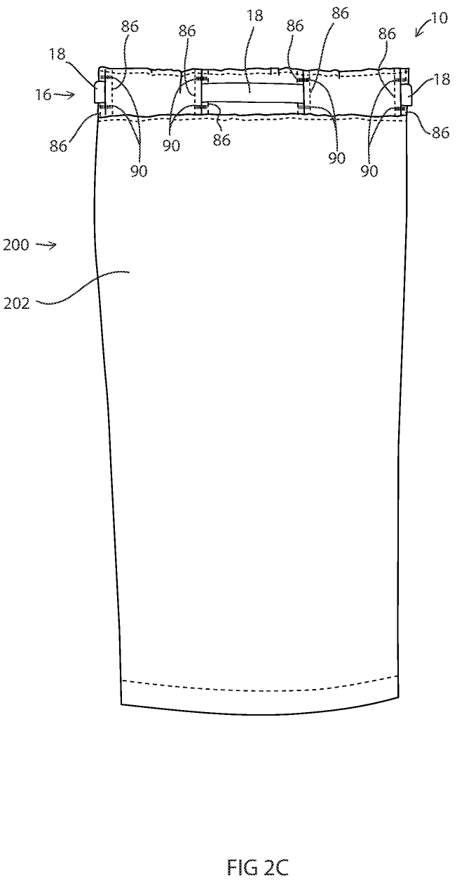

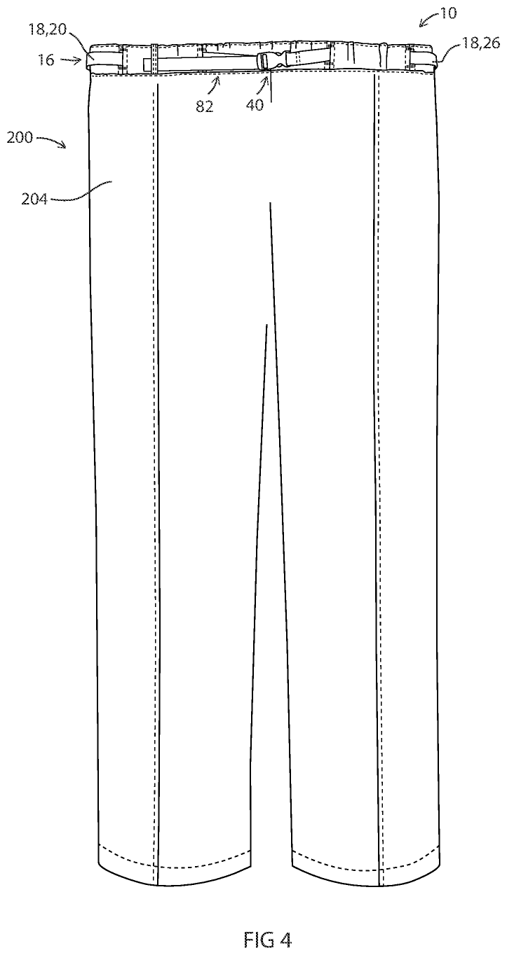

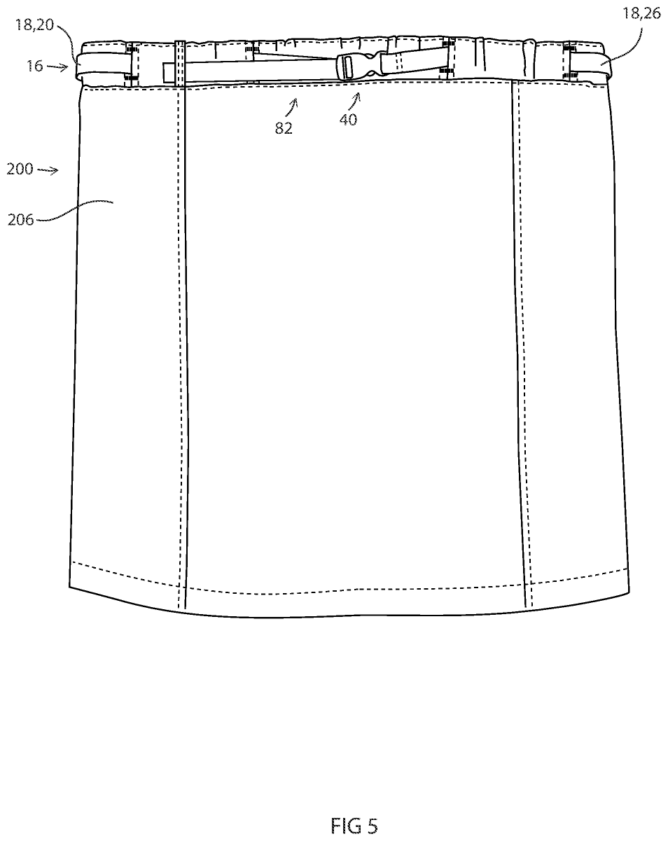

Another feature of waistband 10 configured to assist transferring wearer 12 safely from sitting to standing or standing to sitting may be that it can be configured for use in garment 200. See FIGS. 1-5. Garment 200 that the disclosed waistband 10 is used on may include, but is not limited thereto, pair of shorts 202 (see FIGS. 2A, 2B, 2C, and 3), pair of pants 204 (see FIG. 4), skirt 206 (see FIG. 5), the like, and/or any other various garment or apparel item with a waistband. Each garment 200 may generally include waistband 10 configured to assist transferring wearer 12 safely from sitting to standing or standing to sitting in any of the various embodiments and/or combination of embodiments shown and/or described herein. As such, garment 200 may include waistband 10 configured to assist transferring wearer 12 safely from sitting to standing or standing to sitting. As such, waistband 10 used on any of garments 200 may generally include strong belt material 14 connected along waistline 16 of waistband 10. Strong belt material 14 may be configured to provide plurality of handles 18. Wherein, each of the plurality of handles 18 provided by waistband 10 on garment 200 may be configured to assist in transferring wearer 12 of waistband 10 from sitting to standing or from standing to sitting, like as shown in FIG. 3. As shown in the Figures, garment 200 may be, but is not limited to, pair of shorts 202, pair of pants 204, or skirt 206 (or any other garment with a waistband), wherein, waistband 10 may be connected to pair of shorts 202, pair of pants 2-4, or skirt 206, like as shown in the Figures.

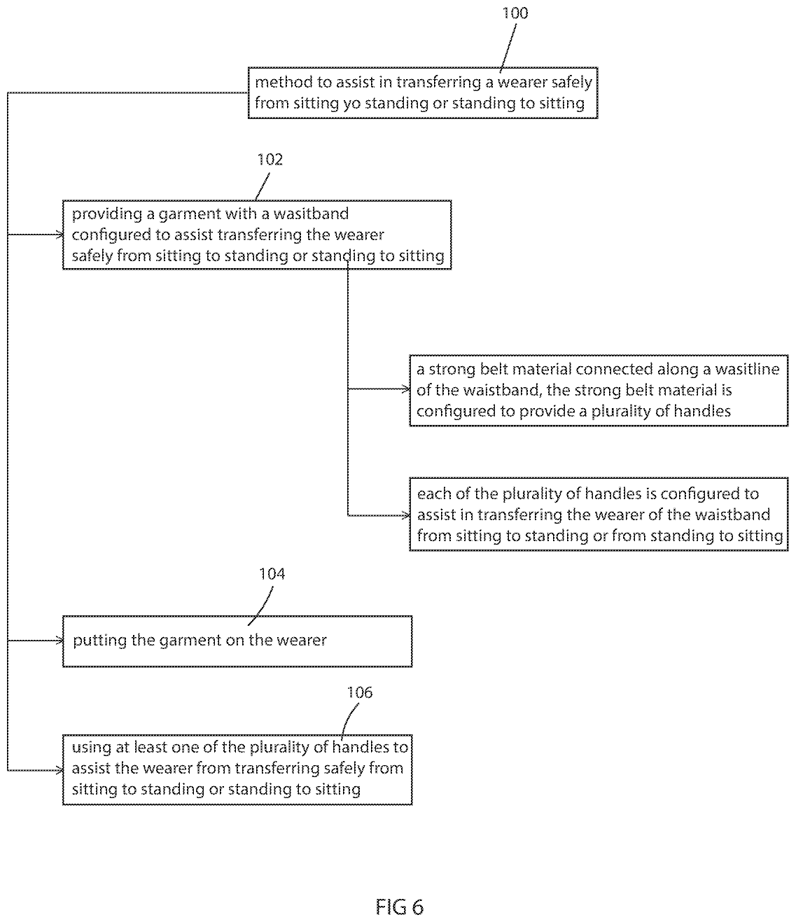

Referring now specifically to FIG. 6, in another aspect, the instant disclosure embraces method 100 to assist in transferring wearer 12 safely from sitting to standing or standing to sitting. Method 100 to assist in transferring wearer 12 safely from sitting to standing or standing to sitting may generally include utilizing waistband 10 and/or garment 200 configured to assist transferring wearer 12 safely from sitting to standing or standing to sitting in any of the various embodiments and/or combination of embodiments shown and/or described herein. As such, method 100 to assist in transferring wearer 12 safely from sitting to standing or standing to sitting may include step 102 of providing garment 200 with waistband 10 configured to assist transferring wearer 12 safely from sitting to standing or standing to sitting. With the provided garment 200, method 100 to assist in transferring wearer 12 safely from sitting to standing or standing to sitting may further include: step 104 of putting garment 200 on wearer 12; and step 106 of using at least one of the plurality of handles 18 on waistband 10 to assist wearer 12 from transferring safely from sitting to standing or standing to sitting.

### Example

An example garment 200 was created with the disclosed waistband 10 configured to assist transferring wearer 12 safely from sitting to standing or standing to sitting. The parts of the created waistband 10 of the example garment include: approximately 1-yard material for strong belt material 14 being a yard of 1″ cotton webbing, a side release buckle (male/female) for connector mechanism 40; an elastic waist band of approximately 1½″; and heavy duty nylon tread.

In sum, the advantages of the disclosed waistband 10, garment 200 and/or method 100 may be that the built-in belt (strong belt material 14) that is inserted inside the waistband, may provide 3 webbing handles 18 for assisting patients. As such, a pair of shorts 202, pair of pants 204, a skirt 206, the like, etc., may be created with three web handles 18 to grab. As of today, a nurse or CNA will pull someone up under their arms or even stick their hand down brief underwear to pull or assist patient. This is not only gross, but very undignified. Accordingly, waistband 10 may provide a device, means, method, and/or mechanism to aid care givers, like nurses or CNAs, in transitioning individuals from sitting to standing and/or from standing to sitting, by providing waistband 10 configured to assist transferring wearer 12 safely from sitting to standing or standing to sitting that is more sanitary and less intrusive to the individual wearer or patient.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A waistband configured to assist transferring a wearer safely from sitting to standing or standing to sitting, the waistband comprising:
a strong belt material connected along a waistline of the waistband, the strong belt material is configured to provide a plurality of handles; and
wherein, each of the plurality of handles is configured to assist in transferring the wearer of the waistband from sitting to standing or from standing to sitting.

2. The waistband of claim 1, wherein the plurality of handles provided by the strong belt material including:
a first handle protruding from a left side of the waistline, the first handle is configured to assist in transferring the wearer of the waistband from sitting to standing or from standing to sitting from a left side of the wearer; and
a second handle protruding on a right side of the waistline, the second handle is configured to assist in transferring the wearer of the waistband from sitting to standing or from standing to sitting from a right side of the wearer.

3. The waistband of claim 2, wherein the plurality of handles provided by the strong belt material further including:
a third handle protruding from a back side of the waistline, the third handle is configured to assist in transferring the wearer of the waistband from sitting to standing or from standing to sitting from a back side of the wearer;
wherein the third handle protruding from the back side of the waistline is larger than the first handle on the left side of the waistline and the second handle on the right side of the waistline; and
wherein the plurality of handles is configured for providing a means to assist in transferring the wearer of the waistband from sitting to standing or from standing to sitting from the left side of the wearer, the right side of the wearer, the back side of the wearer, or a combination thereof.

4. The waistband of claim 1, wherein the strong belt material further comprising a connector mechanism configured to releasably connect a first end of the strong belt material to a second end of the strong belt material; and
wherein the connector mechanism of the strong belt material is positioned on a front side of the waistline, wherein the connector mechanism may be releasably connected for the wearer to put on or remove the waistband.

5. The waistband of claim 4, wherein the connector mechanism is adjustable, whereby a length of the strong belt material may be adjusted for the waistline.

6. The waistband of claim 5, wherein the connector mechanism is a side release buckle with a female end fixed on the first end of the strong belt material and a male end slidably engaged on the second end of the strong belt material, wherein the side release buckle is configured to releasably affix the female end with the male end, and wherein the male end slidably engaged on the second end of the strong belt material is configured to adjust the length of the strong belt material for providing the waistline configured for the wearer.

7. The waistband of claim 1, wherein the strong belt material includes a webbing of approximately 1 yard, wherein the webbing includes a webbing material selected from a group consisting of: cotton, nylon, leather, polyester, self-fabric, and combinations thereof.

8. The waistband of claim 1, wherein the waistline including an elastic band, the elastic band including:
a solid inner covering material;
a slotted outer covering material with a plurality of slots;
an elastic material between the solid inner covering material and the slotted outer covering material;
the strong belt material is arranged in and out of an outside of the elastic band through the plurality of slots of the slotted outer covering material for providing the plurality of handles protruding on the outside of the elastic band; and
wherein the slotted outer covering material including two slots for each of the plurality of handles, whereby the strong belt material may be arranged to protrude out of the elastic band at a location of each of the plurality of handles.

9. The waistband of claim 8, wherein the slotted outer covering material including:
a first left slot and a second left slot configured for a first handle protruding from a left side of the waistline, the first handle is configured to assist in transferring the wearer of the waistband from sitting to standing or from standing to sitting from a left side of the wearer; and
a first right slot and a second right slot configured for a second handle protruding from a right side of the waistline, the second handle is configured to assist in transferring the wearer of the waistband from sitting to standing or from standing to sitting from a right side of the wearer.

10. The waistband of claim 9, wherein the slotted outer covering material further including:
a first back slot and a second back slot configured for a third handle protruding from a back side of the waistline, the third handle is configured to assist in transferring the wearer of the waistband from sitting to standing or from standing to sitting from a back side of the wearer.

11. The waistband of claim 10, wherein the slotted outer covering material further including:
a first front slot and a second front slot configured for a connector member portion on a front side of the waistline, the connector member portion on the front side of the waistline is configured for a connector mechanism configured to releasably connect a first end of the strong belt material to a second end of the strong belt material.

12. The waistband of claim 8, wherein each of the slots of the slotted outer covering material including a reinforcement configured for reinforcing said slot.

13. The waistband of claim 12, wherein the reinforcement of each slot includes vertical topstitching on each side of each slot.

14. The waistband of claim 12, wherein the reinforcement of each slot includes bar tacks on a top side and a bottom side of said slot, the bar tacks are stitched through the solid inner covering material, the slotted outer covering material, and the elastic material.

15. The waistband of claim 8, wherein the elastic band of the waistline including heavy-duty nylon thread stitching configured to provide strength and stability to the elastic band, the heavy-duty nylon thread stitching including top stitching configured for reinforcing the top of the waistline; and
wherein, the waistline providing a breaking strength of approximately 213.6 pound force.

16. The waistband of claim 1 being configured for use in a garment.

17. The waistband of claim 16, wherein the garment being selected from a group consisting of: a pair of shorts; a pair of pants; and a skirt.

18. A garment comprising:
a waistband configured to assist transferring a wearer safely from sitting to standing or standing to sitting, the waistband comprising:
a strong belt material connected along a waistline of the waistband, the strong belt material is configured to provide a plurality of handles; and
wherein, each of the plurality of handles is configured to assist in transferring the wearer of the waistband from sitting to standing or from standing to sitting.

19. The garment of claim 18 being selected from a group consisting of: a pair of shorts; a pair of pants; and a skirt; and
wherein, the waistband is connected to the pair of shorts, the pair of pants, or the skirt.

20. A method to assist in transferring a wearer safely from sitting to standing or standing to sitting comprising:
providing a garment with a waistband configured to assist transferring the wearer safely from sitting to standing or standing to sitting, the waistband comprising:
a strong belt material connected along a waistline of the waistband, the strong belt material is configured to provide a plurality of handles;
wherein, each of the plurality of handles is configured to assist in transferring the wearer of the waistband from sitting to standing or from standing to sitting;
putting the garment on the wearer; and
using at least one of the plurality of handles to assist the wearer from transferring safely from sitting to standing or standing to sitting.
